(19) United States
(12) Patent Application Publication
(10) Pub. No.: US 2026/0106548 A1
(43) Pub. Date: Apr. 16, 2026

(54) STACKABLE SWITCH-MODE CONVERTER

(71) Applicant: TEXAS INSTRUMENTS INCORPORATED, Dallas, TX (US)

(72) Inventors: Saurav BANDYOPADHYAY, Dallas, TX (US); Juan ARANGO, Frisco, TX (US); Neeraj KESKAR, Allen, TX (US)

(21) Appl. No.: 18/917,663

(22) Filed: Oct. 16, 2024

(51) Int. Cl. H02M 3/158

(52) U.S. Cl. CPC H02M 3/158

(57) ABSTRACT

A circuit includes a first transistor, a second transistor, a PWM circuit, a minimum off timer, and a trigger circuit. The first transistor has a first control terminal, and the second transistor has a second control terminal. The PWM circuit has a first output coupled to the first control terminal, a second output coupled to the second control terminal, a first input, and a second input. The minimum off timer has a timer output coupled to a first input the PWM circuit. The trigger circuit has a trigger signal output, a trigger signal input, and a trigger signal received output coupled to the PWM circuit. The trigger circuit includes a latch circuit. The latch circuit has a first latch input coupled to the trigger signal input, a second latch input coupled to the timer output, and a latch output coupled to the second input of the PWM circuit.

### BACKGROUND

A switch mode converter is an electronic circuit that converts an input direct current (DC) voltage into one or more DC output voltages that are higher or lower in magnitude than the input DC voltage. A switch mode converter that generates an output voltage lower than the input voltage is termed a buck or step-down converter. A switch mode converter that generates an output voltage higher than the input voltage is termed a boost or step-up converter. A stackable switch-mode converter is a type of converter that can be connected to other converters of the same type to provide an increase in output current.

### SUMMARY

In one example, a circuit includes a first transistor, a second transistor, a PWM circuit, a minimum off timer, and a trigger circuit. The first transistor has a first control terminal, and the second transistor has a second control terminal. The PWM circuit has a first output coupled to the first control terminal, a second output coupled to the second control terminal, a first input, and a second input. The minimum off timer has a timer output coupled to a first input the PWM circuit. The trigger circuit has a trigger signal output, a trigger signal input, and a trigger signal received output coupled to the PWM circuit. The trigger circuit includes a latch circuit. The latch circuit has a first latch input coupled to the trigger signal input, a second latch input coupled to the timer output, and a latch output coupled to the second input of the PWM circuit.

In another example, a power supply circuit includes a first switch-mode converter and a second switch-mode converter. The first switch-mode converter has a trigger output, and a first current output. The first switch-mode converter is configured to provide a trigger signal having first and second sequential pulses at the trigger output. The first pulse indicates that the first switch-mode converter is providing current at the first current output. The second switch-mode converter has a trigger input coupled to the trigger output, and a second current output coupled to the first current output, the second switch-mode converter includes a trigger circuit, a minimum off timer, a latch circuit, and a pulse width modulation (PWM) circuit. The trigger circuit is configured to receive the trigger signal, and identify the second sequential pulse. The minimum off timer is configured to define a minimum off time during which current flow to the second current output is switched off. The latch circuit is configured to set a trigger received signal to a first state responsive to the second sequential pulse; and set the trigger received signal to a second state responsive to expiration of the minimum off time. The PWM circuit is coupled to the latch circuit. The PWM circuit is configured to enable current flow to the second current output responsive to the trigger received signal having the first state and expiration of the minimum off time.

In a further example, a system includes a processor and a power supply circuit. The processor has a voltage input. The power supply circuit has a voltage output coupled to the voltage input of the processor. The power supply circuit includes an inductor and a switch-mode converter circuit. The inductor has a first terminal coupled to the voltage input of the processor, and a second terminal. The switch-mode converter circuit has a current output coupled to the second terminal of the inductor, and a trigger input configured to receive a trigger signal having first and second sequential pulses. The switch-mode converter includes a trigger circuit and a minimum off timer, a latch circuit, and a PWM circuit. The trigger circuit is configured to receive the trigger signal, and identify the second sequential pulse. The minimum off timer is configured to define a minimum off time during which current flow to the current output is switched off. The latch circuit is configured to set a trigger received signal to a first state responsive to the second sequential pulse; and set the trigger received signal to a second state responsive to expiration of the minimum off time. The PWM circuit coupled to the latch circuit. The PWM circuit is configured to enable current flow to the second current output responsive to the trigger received signal having the first state and expiration of the minimum off time.

### BRIEF DESCRIPTION OF THE DRAWINGS

FIG. 1 is a block diagram of an example stackable switch-mode converter circuit that uses a single trigger signal to control activation.

FIG. 2 is a block diagram of an example trigger circuit suitable for use in the stackable switch-mode converter circuit of FIG. 1.

FIG. 3 is a flow diagram for an example method of trigger control in a state machine of the trigger circuit of FIG. 2.

FIG. 4 is a schematic of an example circuit that may be included in the trigger circuit of FIG. 2 to enable secondary operation.

FIGS. 5A and 5B are timing diagrams showing example signals in the circuit of FIG. 4.

FIG. 6 is a graph of example signals in a power supply that includes the stackable switch-mode converter circuit of FIG. 1.

FIG. 7 is a graph of example power supply operation with and without the trigger circuit of FIG. 2.

FIG. 8 is a block diagram of an example system that includes a power supply using the stackable switch mode converter circuit of FIG. 1.

### DETAILED DESCRIPTION

In stackable switch-mode converters, a primary converter controls one or more secondary converters to regulate output voltage. The primary and secondary converters may communicate via one or more control signals. For example, primary and secondary converters may implement bi-directional signaling to provide handshaking that communicates control and status information between the converters. Some stackable converters implement unidirectional control, in which the primary converter triggers one or more secondary controllers via a single signal. Such implementations reduce the number of pins of a converter integrated circuit, which is advantageous because package size can be reduced. However, with no secondary to primary communication the primary converter may trigger the secondary converter at time when the secondary controller is unable to respond. Failure to respond to a trigger signal received from the primary controller may cause the converter output voltage to drop.

The stackable switch-mode converter circuit described herein uses a single signal for unidirectional communication between primary and secondary converters. The secondary converters include circuitry that records receipt of a trigger signal from the primary converter, and ensures that the secondary device responds by switching current to the current output even if the trigger signal is received at a time when the secondary device is unable to respond.

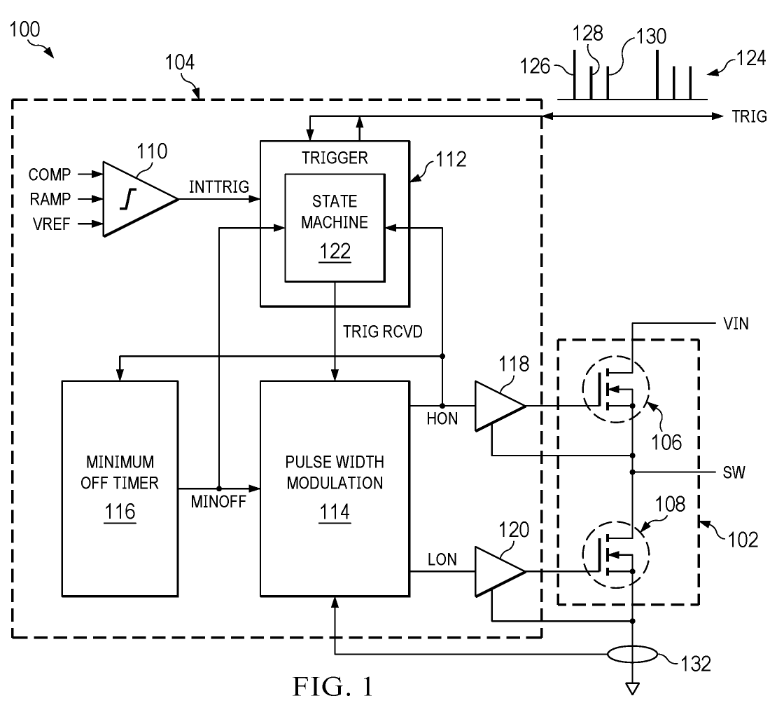

FIG. 1 is a block diagram of an example stackable switch-mode converter circuit 100 that uses a single trigger signal to control activation of secondary converters. The stackable switch-mode converter circuit 100 includes a half-bridge circuit 102, and a control circuit 104. The half-bridge circuit 102 includes a high-side transistor 106 and a low-side transistor 108. The high-side transistor 106 and the low-side transistor 108 may be n-channel field effect transistors (NFETs). The high-side transistor 106 has a first terminal (e.g., drain) coupled to a voltage input terminal (VIN), a second terminal (e.g., source) coupled to a switching terminal (SW), and a control terminal (e.g., gate) coupled to the control circuit 104. The low-side transistor 108 has a first terminal (e.g., drain coupled to the second terminal of the high-side transistor 106, a second terminal (e.g., source) coupled to a reference voltage terminal (e.g., ground), and a control terminal coupled to the control circuit 104. The high-side transistor 106 and the low-side transistor 108 are controlled by the control circuit 104 to provide current from VIN to SW, and to couple SW to the reference voltage terminal.

The control circuit 104 includes a comparator 110, a trigger circuit 112, a pulse width modulation (PWM) circuit 114, a minimum off timer 116, and drivers 118 and 120. The drivers 118 and 120 provide control signals with voltage and current suitable for switching the high-side transistor 106 and the low-side transistor 108 on and off. The driver 118 has an output coupled to the control terminal of the high-side transistor 106, an input coupled to the PWM circuit 114, and a reference terminal coupled to the second terminal of the high-side transistor 106. The driver 120 has an output coupled to the control terminal of the low-side transistor 108, an input coupled to the PWM circuit 114, and a reference terminal coupled to the second terminal of the driver 120.

The PWM circuit 114 generates the transistor control signals HON and LON that control the high-side transistor 106 and the low-side transistor 108 via the driver 118 and the driver 120. HON controls the high-side transistor 106 and LON controls the low-side transistor 108. The PWM circuit 114 has a first output, at which HON is provided, coupled to the input of the driver 118, and a second output, at which LON is provided, coupled to the input of the driver 120. The PWM circuit 114 has inputs coupled to a low-side current sensor 132, the trigger circuit 112, and the minimum off timer 116. The PWM circuit 114 receives a current sense signal from the low-side current sensor 132, a trigger received signal (TRIG RCVD) from the trigger circuit 112, and a minimum off time signal (MINOFF) from the minimum off timer 116. The PWM circuit 114 may initiate turn on of the high-side transistor 106 by setting HON to an on state (e.g., a logic high state) based on the sensed current, TRIG RCVD, and MINOFF. For example, the PWM circuit 114 may set HON to the on state based on the sensed current being below a threshold, TRIG RCVD having a state indicating that a trigger signal has been received, and MINOFF having a state indicating that HON has been in an off state (e.g., logic low state) for a minimum selected duration.

The minimum off timer 116 includes timer circuitry that generates MINOFF. MINOFF defines a minimum time that starts at turn off of the high-side transistor 106 (e.g., HON transitioning to a logic low state), and expires after a predetermined interval (i.e., minimum off time). For example, MINOFF has a first state (e.g., a logic high state) identifying an off time interval following turn off of the high-side transistor 106 (current flow through the high-side transistor 106 is switched off), and a second state (e.g., logic low state) identifying time when the high-side transistor 106 can be turned on.

The comparator 110 compares an error signal (e.g., difference between a converter output voltage and a reference voltage) to a ramp voltage to generate an internal trigger signal (INTTRIG). Circuitry for generating the error signal, ramp signal, and reference voltage is not shown. An output of the comparator 110 is coupled to the trigger circuit 112. The 100 may include other circuitry, such as an error amplifier, compensation circuitry, and other circuits that have been omitted from FIG. 1 in the interest of clarity.

The trigger circuit 112 allows the stackable switch-mode converter circuit 100 to operate as a primary converter or secondary converter by providing trigger signals to the PWM circuit 114 that are based on INTTRIG received from the comparator 110, or based on the trigger signal TRIG received at an input/output (I/O) terminal of the stackable switch-mode converter circuit 100 (e.g., where TRIG is provided by a primary converter). The trigger circuit 112 has a trigger signal output for providing TRIG to secondary converters, and a trigger signal input for receiving TRIG provided by a primary converter. The trigger circuit 112 also has inputs for receiving MINOFF and HON for use as described below. If the stackable switch-mode converter circuit 100 is operating as a primary converter, the trigger circuit 112 generates TRIG to control the operation of the secondary converters, and provides TRIG at the trigger signal output of the trigger circuit 112. The signal 124 is an example of TRIG for three instances of the stackable switch-mode converter circuit 100 coupled in parallel (e.g., one primary converter and two secondary converters). The signal 124 includes a series of sequential pulses, where each pulse represents turn-on (or requested turn-on) of the high-side transistor in a converter. The pulse amplitude distinguishes primary converter control from secondary converter control. The pulse 126 is higher in amplitude than the pulses 128 and 130. For example, the pulse 126 may have an amplitude that is about twice the amplitude of the pulse 128 and the pulse 130 (e.g., 4.5 volts versus 2.25 volts). The pulse 126 represents turn-on of the high-side transistor in the primary converter. The pulse 128 represents the primary converter’s request for a first secondary converter to turn on its high-side transistor to provide current. The pulse 130 represents the primary converter’s request for a second secondary converter to turn on its high-side transistor to provide current.

If the stackable switch-mode converter circuit 100 is operating as a secondary converter, the trigger circuit 112 receives TRIG provided by a primary converter at the trigger signal input of the trigger circuit 112. The trigger circuit 112 identifies the pulse 126 and the pulse 128 or 130 corresponding to the stackable switch-mode converter circuit 100 (depending on whether the stackable switch-mode converter circuit 100 is operating as the first or second secondary converter). For example, the trigger circuit 112 may include comparators to identify the different pulses based on amplitude, and counter circuitry to count the lower amplitude pulses following a higher amplitude pulse. Responsive to identification of the pulse corresponding to the stackable switch-mode converter circuit 100, the trigger circuit 112 may set TRIG RCVD to an on state (e.g., a logic high state) indicating that the PWM circuit 114 should set HON to turn on the high-side transistor 106. However, if the pulse corresponding to the stackable switch-mode converter circuit 100 is received while HON is set to turn on the high-side transistor 106, or while MINOFF is set to disable turn-on of the high-side transistor 106, then the PWM circuit 114 may be unable to respond to TRIG RCVD, and the stackable switch-mode converter circuit 100 may skip a conversion cycle.

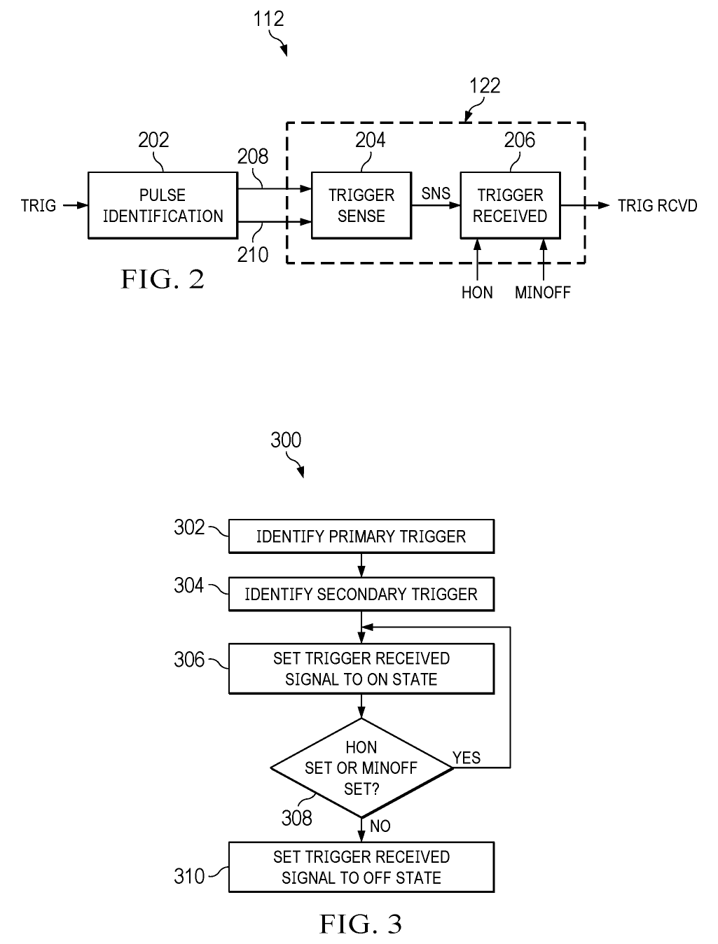

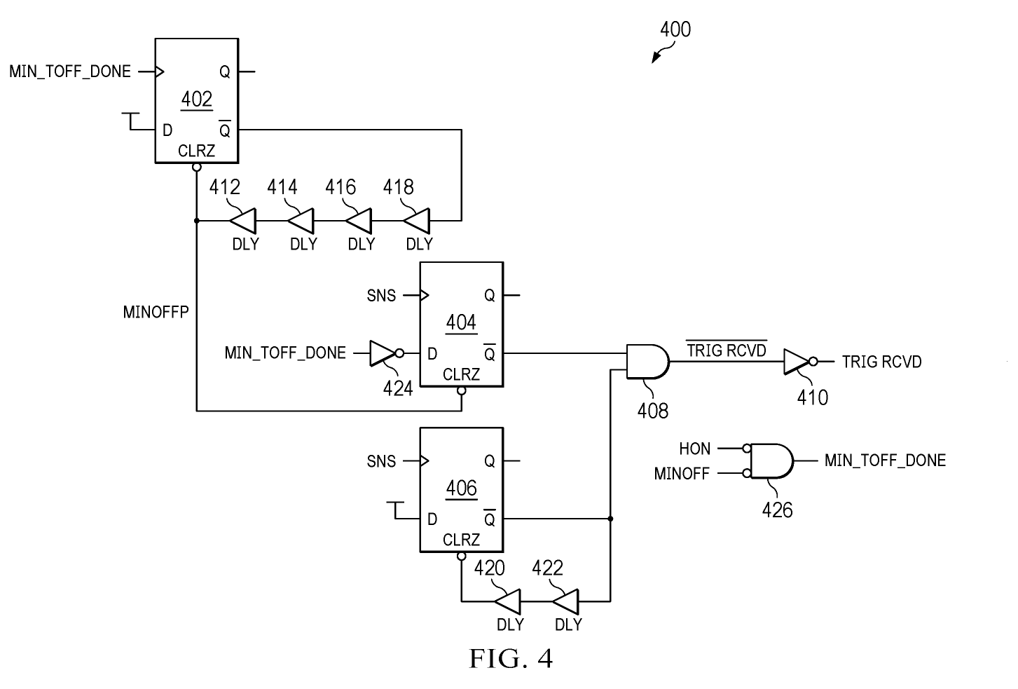

The trigger circuit 112 includes a state machine 122 that latches the pulse corresponding to the stackable switch-mode converter circuit 100. The state machine 122 sets and holds TRIG RCVD in the on state until, for the immediately prior conversion cycle, HON is reset to turn off the high-side transistor 106 and the minimum off time has expired (MINOFF is in the off state), and HON can be set to the on state for the current conversion cycle. Accordingly, the state machine 122 ensures that the stackable switch-mode converter circuit 100 provides current, via the high-side transistor 106, in each conversion cycle, which can improve transient response and output regulation of the stacked converter. Without the state machine 122, the stackable switch-mode converter circuit 100 may fail to respond to a trigger pulse, and the performance of the stacked converter may be adversely affected. The state machine 122 may be implemented using a variety of circuits. FIGS. 2 and 4 illustrate example circuits for implementing the state machine 122. The state machine 122 may also be implemented as synchronous circuitry that provides the functionality described herein.

FIG. 2 is a block diagram of an example trigger circuit 112. The trigger circuit 112 includes a pulse identification circuit 202 and the state machine 122. The example of the state machine 122 shown in FIG. 2 includes a trigger sense circuit 204, and a trigger received circuit 206. If the stackable switch-mode converter circuit 100 is operating as the first secondary converter, the pulse identification circuit 202 receives TRIG provided by the primary converter and identifies the pulses 126 and 128, and provides signal 208 representing identification of the pulse 126, and signal 210 representing identification of the pulse 128.

The trigger sense circuit 204 generates a trigger sense signal (SNS) based on the signals 208 and 210. For example, the trigger sense circuit 204 may set SNS to a first state (e.g., logic high) responsive to the signal 208, and set SNS to a second state (e.g., logic low) responsive to the signal 210.

The trigger received circuit 206 generates TRIG RCVD based on SNS, HON, and MINOFF. For example, the trigger received circuit 206 may include a latch circuit that is set responsive to the transition of SNS from the first state to the second state (SNS transition responsive to the pulse 128). Setting the latch circuit may set TRIG RCVD to the on state. After the latch circuit is set (e.g., a predetermined time after the latch is set), the latch circuit may be reset if HON is in the off state (indicating the high-side transistor 106 is turned off) and MINOFF has the off state (indicating minimum off time has expired). Resetting the latch circuit may set TRIG RCVD to the off state. Accordingly, the state machine 122 holds TRIG RCVD in the on state until the PWM circuit 114 can set HON to turn on the high-side transistor 106 ensuring that the stackable switch-mode converter circuit 100 does not skip a conversion cycle.

FIG. 3 is a flow diagram for an example method 300 of trigger control in a secondary converter. Though depicted sequentially as a matter of convenience, at least some of the actions shown can be performed in a different order and/or performed in parallel. Additionally, some implementations may perform only some of the actions shown. Operations of the method 300 may be performed by an example of the trigger circuit 112.

In block 302, the trigger circuit 112 is receiving TRIG. The trigger circuit 112 may compare TRIG to a first threshold to identify the pulse 126. The pulse 126 is the primary trigger pulse, which indicates that the high-side transistor 106 of the primary converter is turning on.

In block 304, the trigger circuit 112 is receiving TRIG. The trigger circuit 112 may compare TRIG to a second threshold to identify the pulse 128. For example, pulses having an amplitude that is greater than second threshold and less than the first threshold, such as the pulse 128, may be identified as secondary trigger pulses.

In block 306, the trigger circuit 112 sets TRIG RCVD to the on state responsive to identification of the pulse 128. Setting TRIG RCVD to the on state may include setting a latch to first state.

In block 308, the trigger circuit 112 determines whether HON has an on state (e.g., logic high) to turn on the high-side transistor 106 or MINOFF has an on state (e.g., logic high) indicating that the minimum off time following transition of HON to an off state has not expired. If HON or MINOFF is in the on state, then the method 300 continues in block 306. That is, TRIG RCVD remains set pending HON and MINOFF changing to an off state.

If HON and MINOFF are in the off state, then the trigger circuit 112 resets TRIG RCVD to the off state in block 310. Resetting TRIG RCVD to the off state may include setting the latch to a second state. The PWM circuit 114 detects TRIG RCVD having the on state, and HON and MINOFF having the off state, and in response may set HON to the on state.

FIG. 4 is a schematic of a circuit 400 that may be a part of the state machine 122 that generates TRIG RCVD for secondary operation. The circuit 400 includes flip-flops 402, 404, and 406, a logic gate 408, inverters 410 and 424, and delay circuits 412, 414, 416, 418, 420, and 422. The flip-flop 402 and the delay circuits 412, 414, 416, and 418 are connected as a pulse generator that provides a pulse having a width of the delay provided by the delay circuits 412, 414, 416, and 418 at the rising edge of the signal MIN_TOFF_DONE. In various implementations of the circuit 400, any number of delay circuits may be used to produce a desired pulse width. The flip-flop 402 has a data input coupled to a voltage terminal, and a clock input coupled to an output of the logic gate 426 that provides MIN_TOFF_DONE. The logic gate 426 sets MIN_TOFF_DONE to a logic high state if HON and MINOFF are logic low (the high-side transistor 106 is turned off and the minimum off time has expired). The delay circuits 412, 414, 416, and 418 are coupled in series between an output of the flip-flop 402 and a reset input of the flip-flop 402. A pulse signal (MINOFFP) provided at the output of the flip-flop 402 changes state (to a logic low) at the rising edge of MIN_TOFF_DONE. The logic low propagates through the delay circuits 412, 414, 416, and 418, and resets the flip-flop 402 causing the pulse signal to transition to a logic high state.

The flip-flop 404 has a data input that receives MIN_TOFF_DONE via the inverter 424, a clock input coupled to the output of the 204 for receipt of SNS, and reset input coupled to the reset input of the flip-flop 402. If MIN_TOFF_DONE is a logic low at the rising edge of SNS, then the output signal provided at the output of the flip-flop 404 transitions to a logic low, and remains a logic low until the flip-flop 404 is reset by the pulse generated by the flip-flop 402. Accordingly, the output signal provided at the output of the flip-flop 404 may have a logic low state from the rising edge of SNS to the rising edge of MIN_TOFF_DONE.

The flip-flop 406 has a data input coupled to a voltage terminal, a clock input coupled to the clock input of the flip-flop 404, and a reset input coupled to an output of the flip-flop 406 via the delay circuits 420 and 422. An output signal provided at the output of the flip-flop 406 transitions to a logic low at the rising edge of the SNS, and transitions back to a logic high when the logic low propagates to the reset input of the flip-flop 406 through the delay circuits 420 and 422. Accordingly, the flip-flop 406 generates a relatively short pulse at the rising edge of SNS. In various implementations of the circuit 400, any number of delay circuits may be used to produce a desired pulse width.

The logic gate 408 has an input coupled to the output of the flip-flop 404, and an input coupled to the output of the flip-flop 406. An output of the logic gate 408 is coupled to an input of the inverter 410, and TRIG RCVD is provided at the output of the inverter 410. Accordingly, TRIG RCVD may be a short pulse provided by the flip-flop 406 if MIN_TOFF_DONE is a logic high at the rising edge of SNS, or TRIG RCVD may extend from the rising edge of SNS to the rising edge of MIN_TOFF_DONE if MIN_TOFF_DONE is a logic low at the rising edge of SNS.

The functionality of the circuit 400 may also be implemented using circuits that are different from those shown in FIG. 4. For example, synchronous circuits may be implemented to provide functionality that is the same or similar to that of the circuit 400.

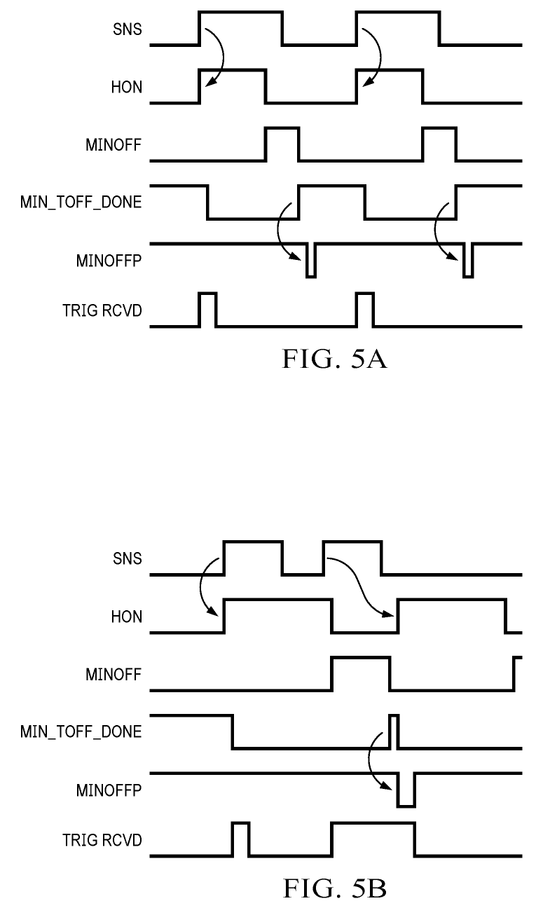

FIG. 5A is a timing diagram showing signals in the circuit 400 when MIN_TOFF_DONE is a logic high at the rising edge of SNS, and TRIG RCVD is the short pulse generated by the flip-flop 406.

FIG. 5B is a timing diagram showing signals in the circuit 400 when MIN_TOFF_DONE is a logic low at the rising edge of SNS, and TRIG RCVD is a logic high between the rising edge of SNS and the rising edge of MIN_TOFF_DONE.

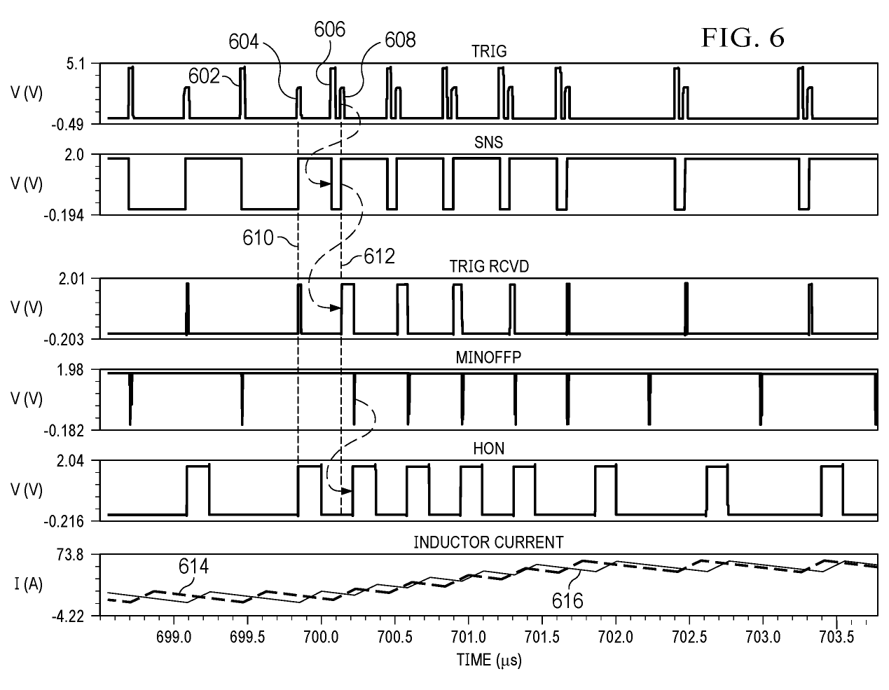

FIG. 6 is a graph of example signals in a power supply that includes two examples of the stackable switch-mode converter circuit 100 (e.g., a primary converter and a secondary converter). FIG. 6 shows examples of the trigger signal TRIG received by the secondary converter, and signals SNS, TRIG RCVD, and HON generated by the secondary converter. FIG. 6 also shows inductor current 614 for the primary converter, inductor current 616 for the secondary converter, and a signal MINOFFP generated by the secondary converter. MINOFFP is a pulse at the trailing edge of MINOFF, which indicates that the minimum off time has expired. The TRIG signal includes primary and secondary trigger pulses. The primary trigger pulse has a greater amplitude (higher voltage) than the secondary trigger pulse. SNS is set to a logic low by each primary trigger pulse and to a logic high by each secondary trigger pulse. TRIG RCVD is set to a logic high at each low to high transition of SNS.

At time 610, corresponding to the secondary pulse 604 (following primary pulse 602), HON has the off state and MINOFFP has been generating (indicating that MINOFF is in the off state). Accordingly, HON is set to the on state without delay responsive to TRIG RCVD, and TRIG RCVD is reset to logic low state.

At time 612, corresponding to the secondary pulse 608 (following primary pulse 606), HON has the off state, but MINOFFP has not yet been generated (indicating that MINOFF is in the on state). Accordingly, HON cannot be immediately set to the on state responsive to TRIG RCVD. The state machine 122 holds TRIG RCVD in the logic high state until the minimum off time expires and MINOFFP is generated. Thereafter, HON is set to the on state. With generation of MINOFFP and/or setting of HON to the on state, TRIG RCVD is reset to logic low state. By extending TRIG RCVD until the minimum off time expires and/or HON is set to the on state, the state machine 122 ensures that the secondary converter does not skip a conversion cycle, and the transient performance of the stacked converter is improved.

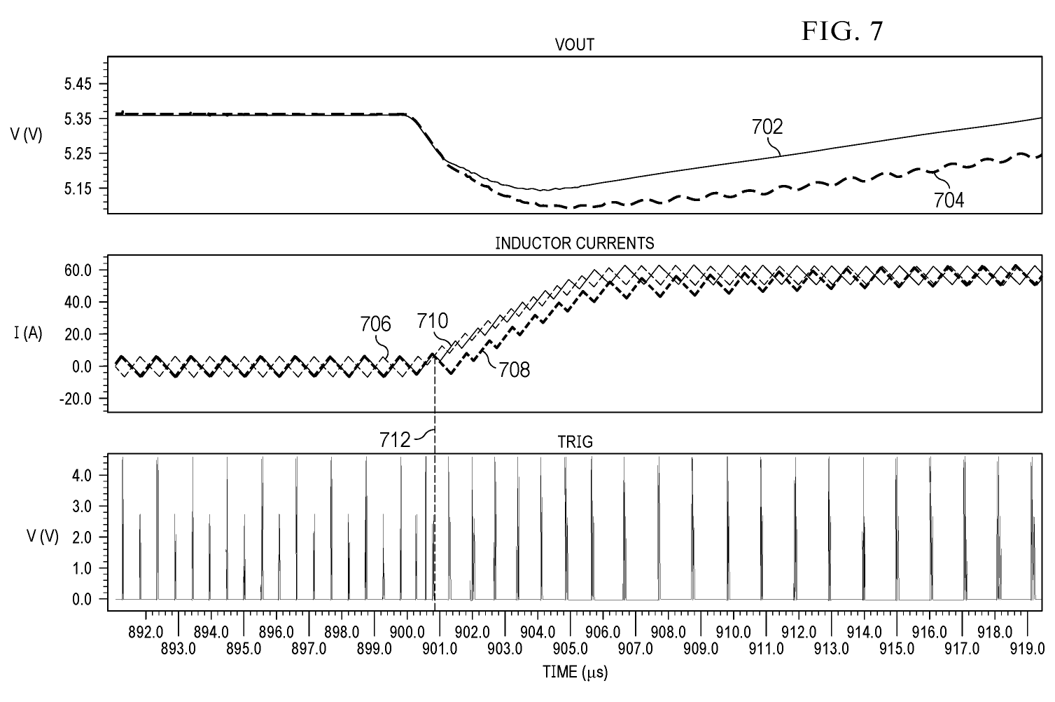

FIG. 7 is a graph of example power supply operation with and without the stackable switch-mode converter circuit 100 in a power supply with a primary converter and a secondary converter. FIG. 7 shows the signal TRIG received by the secondary converter, inductor current 706 in the primary converter, inductor current 708 in the secondary converter without the stackable switch-mode converter circuit 100, and inductor current 710 in the secondary converter with the stackable switch-mode converter circuit 100. FIG. 5 also shows output voltage (VOUT) 702 of the stacked converter with the stackable switch-mode converter circuit 100, and VOUT 704 of the stacked converter without the stackable switch-mode converter circuit 100.

TRIG includes primary and secondary trigger pulses, where the primary pulses are higher in amplitude than the secondary pulses. At time 712 the secondary trigger pulse has been provided closer to the primary pulse than in previous cycles due to an increase in load current. The inductor current 708 shows that the without the stackable switch-mode converter circuit 100 the secondary converter is unable to respond, and the secondary converter provides no current (the secondary converter skips a cycle). The inductor current 710 shows that with the stackable switch-mode converter circuit 100 response of the secondary converter is delayed until the minimum off time from the previous cycle has expired, but the secondary converter does provide current (the secondary converter does not skip a cycle).

VOUT 702 and 704 show that with the stackable switch-mode converter circuit 100, the transient response of the stacked converter is significantly improved relative to without the stackable switch-mode converter circuit 100.

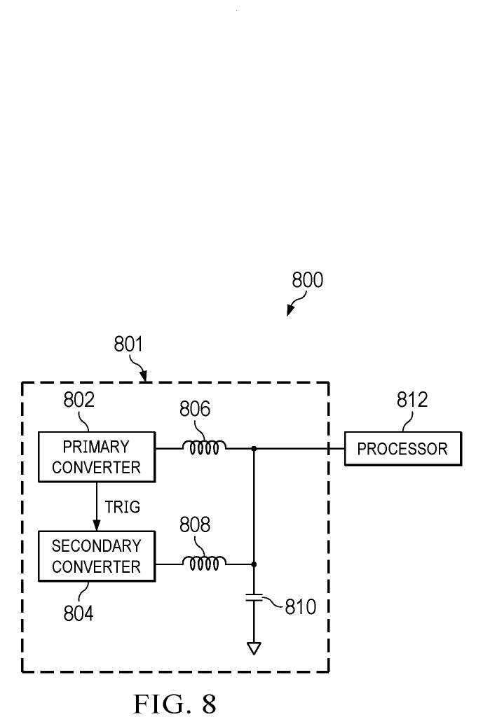

FIG. 8 is a block diagram of an example system 800 that includes a power supply using the stackable switch-mode converter circuit 100. The system 800 includes a power supply circuit 801 and a processor 812. The processor 812 may be a general purpose microprocessor, a digital signal processor, a graphics processor, or any other type of processor used in a computer or computing application. The power supply circuit 801 includes a primary converter 802, a secondary converter 804, an inductor 806, an inductor 808, and a capacitor 810. Some implementations of the power supply circuit 801 may include more than one secondary converter. The power supply circuit 801 generates voltage for powering the processor 812. The primary converter 802 and the secondary converter 804 are examples of the stackable switch-mode converter circuit 100. The primary converter 802 has a TRIG output that is coupled to a TRIG input of the secondary converter 804. The primary converter 802 provides TRIG at the TRIG output to control operation of the secondary converter 804. The switching terminal of the primary converter 802 is coupled to a first terminal of the inductor 806, and a second terminal of the inductor 806 is coupled to a first terminal of the capacitor 810. The switching terminal of the secondary converter 804 is coupled to a first terminal of the inductor 808, and a second terminal of the inductor 808 is coupled to the second terminal of the inductor 806. The first terminal of the capacitor 810 is coupled to a voltage input terminal of the processor 812, and a second terminal of the capacitor 810 is coupled to a reference terminal (e.g., ground).

The primary converter 802 and the secondary converter 804 enable the power supply circuit 801 to provide significantly better transient response than other stacked converters using a single signal control interface, while also reducing integrated circuit package size relative to converters using a multi-signal control interface. Examples of the power supply circuit 801 may be used in a wide variety of applications, including computing, communications, industrial, and other applications.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) (n-type transistor) or a p-channel FET (PFET) ) (p-type transistor)), a bipolar junction transistor (BJT – e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor’s control input and its current terminals. In the context of a FET, the control input (or transistor control terminal) is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor’s body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/- 10 percent of that parameter or, if the parameter is zero, a reasonable range of values around zero.

Modifications are possible in the described embodiments, and other embodiments are possible, within the scope of the claims.

What is claimed is:

1. A circuit comprising:
a first transistor having a first control terminal and a second transistor having a second control terminal;
a pulse width modulation (PWM) circuit having a first output coupled to the first control terminal, a second output coupled to the second control terminal, a first input, and a second input;
a minimum off timer having a timer output coupled to a first input the PWM circuit; and
a trigger circuit having a trigger signal output, a trigger signal input, and a trigger signal received output coupled to the PWM circuit, the trigger circuit including a latch circuit having a first latch input coupled to the trigger signal input, a second latch input coupled to the timer output, and a latch output coupled to the second input of the PWM circuit.

2. The circuit of claim 1, wherein the trigger circuit is configured to:
generate a trigger signal having first and second sequential pulses, the first sequential pulse indicating that the first transistor is turned on; and
provide the trigger signal at the trigger signal output.

3. The circuit of claim 1, wherein the trigger circuit is configured to receive a trigger signal at the trigger signal input, the trigger signal having a first and second sequential pulses, the second sequential pulse indicating that the first transistor is to be turned on.

4. The circuit of claim 3, wherein an amplitude of the first sequential pulse is greater than an amplitude of the second sequential pulse.

5. The circuit of claim 3, wherein the latch circuit is configured to:
provide a trigger received signal at the latch output;
set the trigger received signal to a first state responsive to the second sequential pulse; and
set the trigger received signal to a second state responsive to expiration of a minimum off time generated by the minimum off timer.

6. The circuit of claim 5, wherein the PWM circuit is configured to:
provide a transistor control signal at the first output of the PWM circuit; and
set the transistor control signal to the first state responsive to the trigger received signal having the first state and the expiration of the minimum off time.

7. The circuit of claim 6, wherein the latch circuit is configured to set the trigger received signal to a second state responsive to the transistor control signal having the second state.

8. A power supply circuit comprising:
a first switch-mode converter having a trigger output, and a first current output, the first switch-mode converter configured to provide a trigger signal having first and second sequential pulses at the trigger output, the first sequential pulse indicating that the first switch-mode converter is providing current at the first current output;
a second switch-mode converter having a trigger input coupled to the trigger output, and a second current output coupled to the first current output, the second switch-mode converter including:
a trigger circuit configured to receive the trigger signal, and identify the second sequential pulse;
a minimum off timer configured to define a minimum off time during which current flow to the second current output is disabled;
a latch circuit configured to set a trigger received signal to a first state responsive to the second sequential pulse; and set the trigger received signal to a second state responsive to expiration of the minimum off time; and
a pulse width modulation (PWM) circuit coupled to the latch circuit, the PWM circuit configured to enable current flow to the second current output responsive to the trigger received signal having the first state and expiration of the minimum off time.

9. The power supply circuit of claim 8, wherein the latch circuit is configured to set the trigger received signal to the second state based on current flow to the second current output being disabled.

10. The power supply circuit of claim 8, wherein the latch circuit is configured to set the trigger received signal to the first state based on current flow to the second current output being enabled or the minimum off time being not expired.

11. The power supply circuit of claim 8, wherein the first sequential pulse has a first amplitude, and the second sequential pulse has a second amplitude.

12. The power supply circuit of claim 11, wherein the first amplitude is greater than the second amplitude.

13. The power supply circuit of claim 8, wherein the trigger circuit includes:
a sense circuit configured to set a sense signal to a first state responsive to the second sequential pulse and set the sense signal to a second state responsive to the first sequential pulse; and
a latch circuit configured to set the trigger received signal to the first state responsive to the sense signal changing from the second state to the first state.

14. The power supply circuit of claim 8, wherein the minimum off timer is configured to start the minimum off time responsive to the PWM circuit disabling current flow to the second current output.

15. A system comprising:
a processor having a voltage input; and
a power supply circuit having a voltage output coupled to the voltage input of the processor, the power supply circuit including:
an inductor having a first terminal coupled to the voltage input of the processor, and a second terminal;
a switch-mode converter circuit having a current output coupled to the second terminal of the inductor, and a trigger input configured to receive a trigger signal having first and second sequential pulses, the switch-mode converter circuit including:
a trigger circuit configured to receive the trigger signal, and identify the second sequential pulse;
a minimum off timer configured to define a minimum off time during which current flow to the current output is disabled;
a latch circuit configured to set a trigger received signal to a first state responsive to the second sequential pulse; and set the trigger received signal to a second state responsive to expiration of the minimum off time; and
a pulse width modulation (PWM) circuit coupled to the latch circuit, the PWM circuit configured to enable current flow to the current output responsive to the trigger received signal having the first state and expiration of the minimum off time.

16. The system of claim 15, wherein an amplitude of the first sequential pulse is greater than the amplitude of the second sequential pulse.

17. The system of claim 15, wherein the latch circuit is configured to set the trigger received signal to the second state based on current flow to the current output being disabled.

18. The system of claim 15, wherein the latch circuit is configured to set the trigger received signal to the first state based on current flow to the current output being enabled or the minimum off time being not expired.

19. The system of claim 15, wherein the trigger circuit includes:
a sense circuit configured to set a sense signal to a first state responsive to the second sequential pulse and set the sense signal to a second state responsive to the first sequential pulse; and
a latch circuit configured to set the trigger received signal to the first state responsive to the sense signal changing from the second state to the first state.

20. The system of claim 15, wherein the minimum off timer is configured to start the minimum off time responsive to the PWM circuit disabling current flow to the current output.
